(19) United States
(12) Patent Application Publication
(10) Pub. No.: US 2026/0252227 A1
(43) Pub. Date: Aug. 27, 2026

(54) DYNAMIC USER INTERFACES FOR MODIFYING GENERATIVE AI PROMPTS

(71) Applicant: AUTODESK, INC., San Francisco, CA (US)

(72) Inventors: David LEDO MAIRA, Toronto (CA); George William FITZMAURICE, Toronto (CA); Tovi GROSSMAN, Toronto (CA); Joanne Sau Ling LEONG, Markham (CA); Fraser ANDERSON, Newmarket (CA)

(21) Appl. No.: 19/297,957

(22) Filed: Aug. 12, 2025

Related U.S. Application Data
(60) Provisional application No. 63/763,135, filed on Feb. 25, 2025.

(51) Int. Cl. G06F 3/04847; G06F 16/532

(52) U.S. Cl. CPC G06F 3/04847; G06F 16/532

(57) ABSTRACT

One embodiment sets forth a technique for generating prompts for generative artificial intelligence (AI) models. According to some embodiments, the technique can include the steps of receiving an initial prompt comprising natural language; generating a plurality of parameterized prompt attributes based on the initial prompt; generating a plurality of UI elements based on the parameterized prompt attributes; receiving user input modifying one or more of the UI elements; and generating an updated prompt based on the initial prompt and the user input.

### CROSS-REFERENCE TO RELATED APPLICATIONS

The present application claims the benefit of U.S. Provisional Application titled, “TECHNIQUES FOR IMPLEMENTING DYNAMIC SLIDERS FOR ARTIFICIAL INTELLIGENCE IMAGE GENERATION,” filed on Feb. 25, 2025, and having Ser. No. 63/763,135. The subject matter of this related application is hereby incorporated herein by reference.

### BACKGROUND

### Field of the Various Embodiments

Embodiments of the present disclosure relate generally to computer science, artificial intelligence, complex software applications, and, more specifically, to techniques for implementing dynamic user interfaces to modify generative artificial intelligence (AI) prompts.

### Description of the Related Art

Generative AI for images and 3D models relies on natural language prompts to generate outputs that match an intent of a user. Natural language prompts often contain adjectives, values, or stylistic terms—also referred to herein as parameterized prompt attributes—that influence outputs of generative AI. However, the inherent ambiguity and subjectivity of natural language make precise control over the outputs of generative AI challenging for users. As generative AI becomes more integrated into workflows across industries, a growing need exists for generative AI that enables users to fine-tune outputs intuitively and precisely without repeatedly rewriting prompts or guessing at the right wording.

Currently, conventional methods that influence outputs of generative AI rely primarily on manipulation of natural language prompts. Through natural language prompts, users modify parameterized prompt attributes to influence outputs of generative AI. This trial-and-error process typically involves rephrasing natural language prompts multiple times, regenerating content, and visually inspecting the outputs. Furthermore, such workflows for generative AI depend on linguistic skills of users and familiarity with the sensitivities of a model that is trained for generating images or 3D models.

One drawback of traditional approaches for generating images and 3D models is the limited precision and control over parameterized prompt attributes through natural language prompts that influence the outputs of generative AI. Because parameterized prompt attributes are embedded into natural language phrases, modification of parameterized prompt attributes requires rewriting the prompt or substituting new descriptive terms. This process introduces ambiguity, making it unclear how changes in language affect outputs of generative AI and to what extent. As a result, processes associated with traditional approaches are often time-intensive, necessitate iterative repetition, and require users to adjust specificity or combine descriptive terms to achieve user intent. The time-intensive aspect of these processes is especially pronounced for users unfamiliar with language sensitivities of both the model and natural language, leading to inconsistent outputs of generative AI.

Another drawback of traditional approaches is the low granularity of detail achievable through brief natural language prompts and the resulting excessive computational overhead incurred by repeated generation cycles. Because users input short, often underspecified prompts, output of generative AI may lack nuanced detail or fail to capture subtle variations in parameterized prompt attributes. To compensate, users frequently submit successive, minimally modified prompts that each require a full model invocation, which consumes unnecessary processing resources, increases response latency, and can cause strain on underlying computational system resources. Moreover, the absence of persistent, structured inputted parameter records makes it difficult to reproduce or version past settings, further complicating collaborative refinement and hindering reuse of successful prompt configurations.

As the foregoing illustrates, what is needed in the art are more effective techniques for modifying prompt attributes in generative AI.

### SUMMARY

One embodiment sets forth a computer-implemented method for generating prompts for generative artificial intelligence (AI) models. According to some embodiments, the method can include receiving an initial prompt comprising natural language; generating a plurality of parameterized prompt attributes based on the initial prompt; generating a plurality of UI elements based on the parameterized prompt attributes; receiving user input modifying one or more of the UI elements; and generating an updated prompt based on the initial prompt and the user input.

One technical advantage of the disclosed techniques relative to the prior art is that the disclosed techniques enable more precision and control over parameterized prompt attributes. As a result, the outputs of generative AI can more accurately align with user intent. Specifically, given that the disclosed techniques do not rely on semantic ambiguity inherent in text-based prompts, users no longer need to anticipate which terms best meet user intent. Another technical advantage of the disclosed techniques includes greater time efficiency and a more rapid convergence to a user-intended output of generative AI. In particular, the disclosed techniques also mitigate trial-and-error processes associated with manual prompt rewriting, thereby decreasing the number of cycles required to achieve a satisfactory output of generative AI. As the number of cycles diminishes, resource consumption and latency also decline.

An additional technical advantage of the disclosed techniques includes the improved overall quality and consistency of generative outputs, together with reduced computational overhead. By exposing prompt attributes as discrete, parameterized parameters, the generative AI system can ensure that each iterative adjustment generates predictable changes in outputs of generative AI, which minimizes off-target artifacts and variability. Consequently, fewer generation cycles are needed to reach user-satisfactory outputs, which can conserve processing resources (e.g., GPU time, memory) and also reduce environmental impact.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a system configured to implement one or more aspects of various embodiments.

FIG. 2 illustrates a detailed view of the software application of FIG. 1, according to various embodiments.

FIG. 3 illustrates a detailed view of a workflow diagram, according to various embodiments.

FIGS. 4A-4F illustrate conceptual diagrams of user interfaces associated with a software application executing on one of the endpoint devices of FIG. 1, according to various embodiments.

FIG. 5 sets forth a flow diagram of method steps for generating dynamic user interfaces to modify generative AI prompts, according to various embodiments.

FIG. 6 illustrates a method for generating user interface slider elements based on parameterized prompt attributes, according to various embodiments.

FIG. 7 is a more detailed illustration of a computing device that can implement the functionalities of the entities illustrated in FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

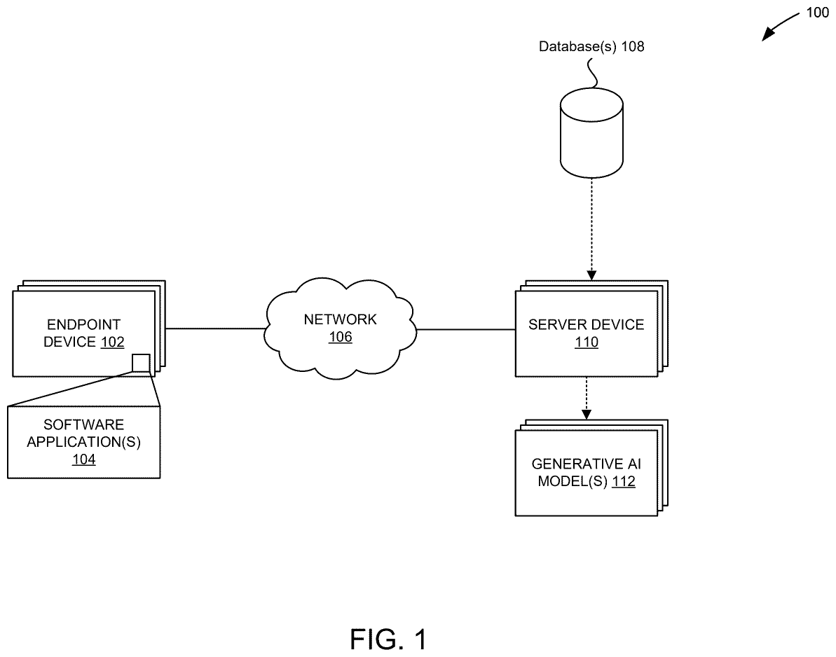

FIG. 1 is a block diagram of a system 100 configured to implement one or more aspects of the various embodiments. As shown, the system 100 includes at least one endpoint device 102, at least one server device 110, at least one database 108, and at least one generative AI model 112, which can communicate with one another via a communications network 106. The communications network 106 can represent, for example, any technically feasible network or number of networks, including a wide area network (WAN) such as the Internet, a local area network (LAN), a Wi-Fi network, a cellular network, or a combination thereof.

According to some embodiments, an endpoint device 102 can represent a computing device (e.g., a desktop computing device, a laptop computing device, a mobile computing device, etc.). As shown in FIG. 1, at least one software application 104 can be installed on and execute on the endpoint device 102. The software application 104 can represent, for example, a web browser application, a web browser application extension, or a productivity application that enables information for building assembly designs to be generated, imported, or modified in accordance with the techniques described herein. In one example, the software application 104 represents a software application for generating user interface (UI) elements that enable modification of prompt attributes in generative AI.

According to some embodiments, the software application 104 can be configured to facilitate data collections or user interactions to enable the software application 104 and/or the server device 110 to implement the various techniques described herein. In particular, the software application 104 can collect and transmit input data required by the server device 110. In turn, the server device 110 can transmit output data to the software application 104, at which point the software application 104 can display the output data and enable the user to interact with the output data (e.g., via one or more user interfaces). It should be appreciated that, in some embodiments, the software application 104 can implement the techniques herein independent from the server device 110, consistent with the scope of this disclosure.

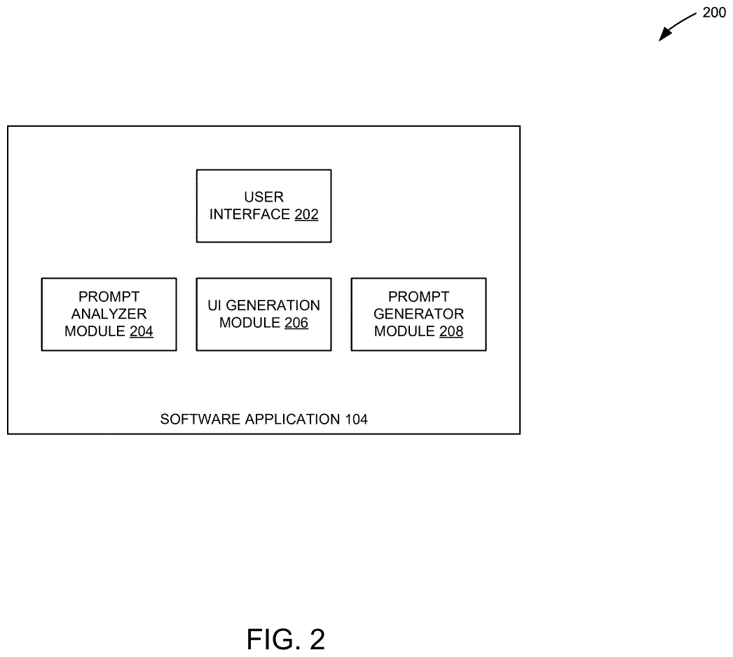

According to some embodiments, the generative AI models 112 can represent one or more trained machine learning models. For example, the generative AI models 112 can be implemented as large language models, computer vision models, graph neural networks, or other advanced architectures. As described in greater detail below in conjunction with FIGS. 2-4F, the generative AI models 112 can be trained to extract prompt attributes, generate UI elements, generate prompts, and so on. The generative AI models 112 can also be configured to convert abstract data types between different formats.

FIG. 2 illustrates a detailed view 200 of the software application 104 of FIG. 1, according to various embodiments. As shown in FIG. 2, the software application 104 includes a user interface 202, a prompt analyzer module 204, a UI generation module 206, and a prompt generator module 208.

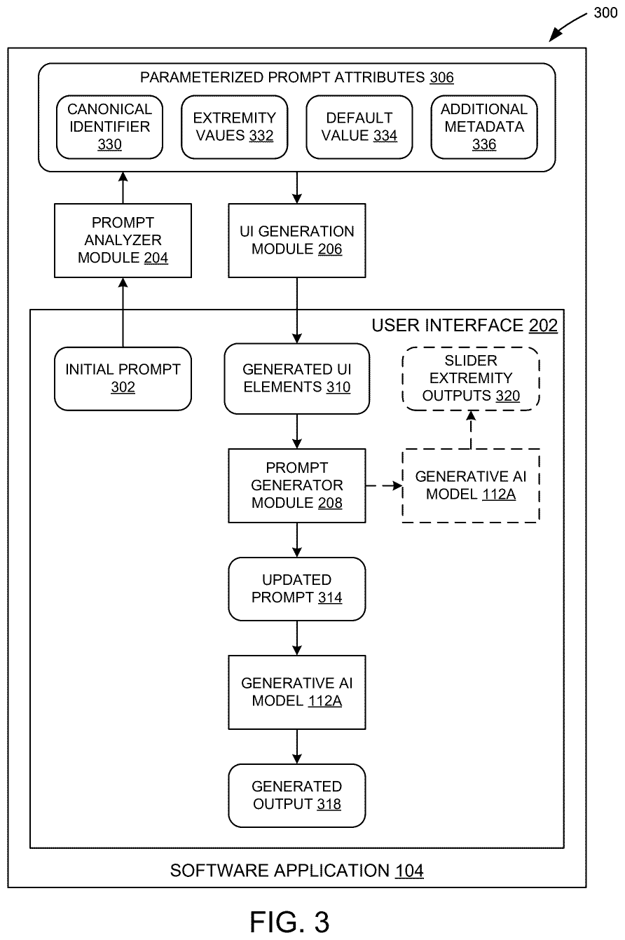

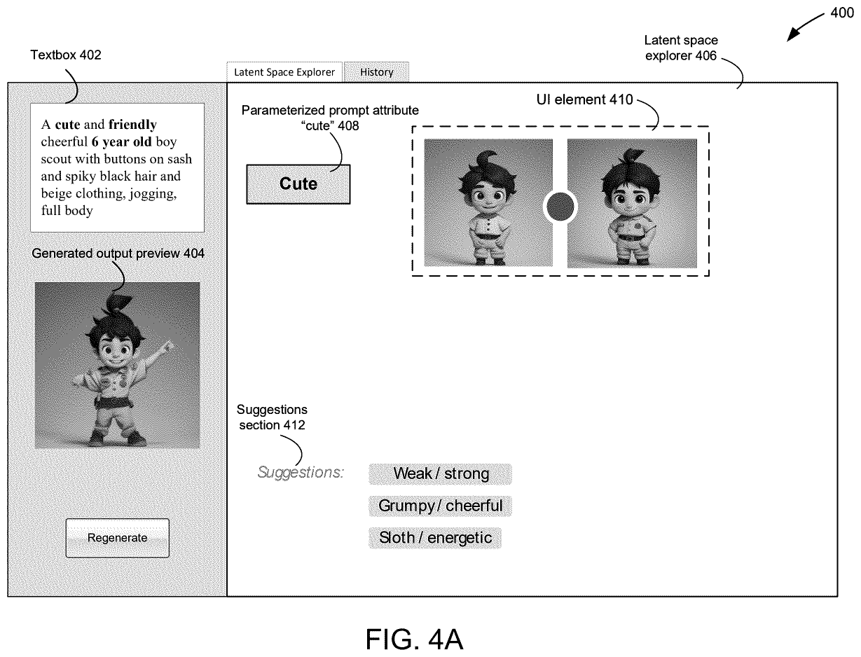

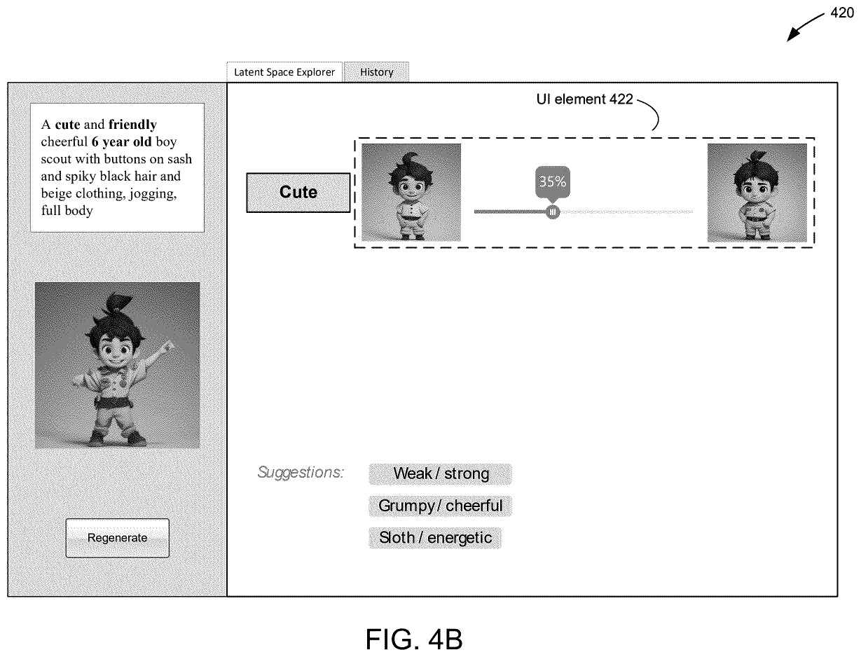

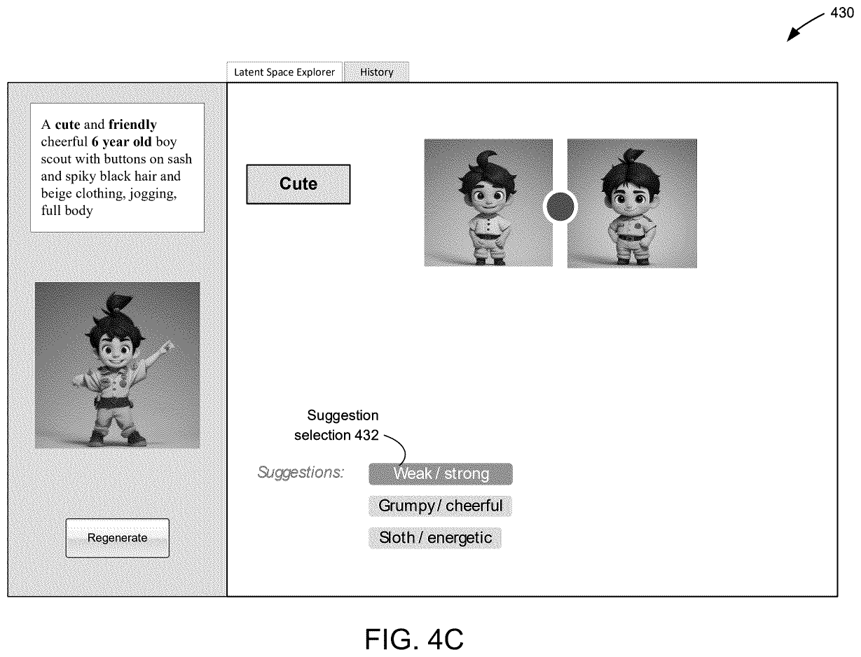

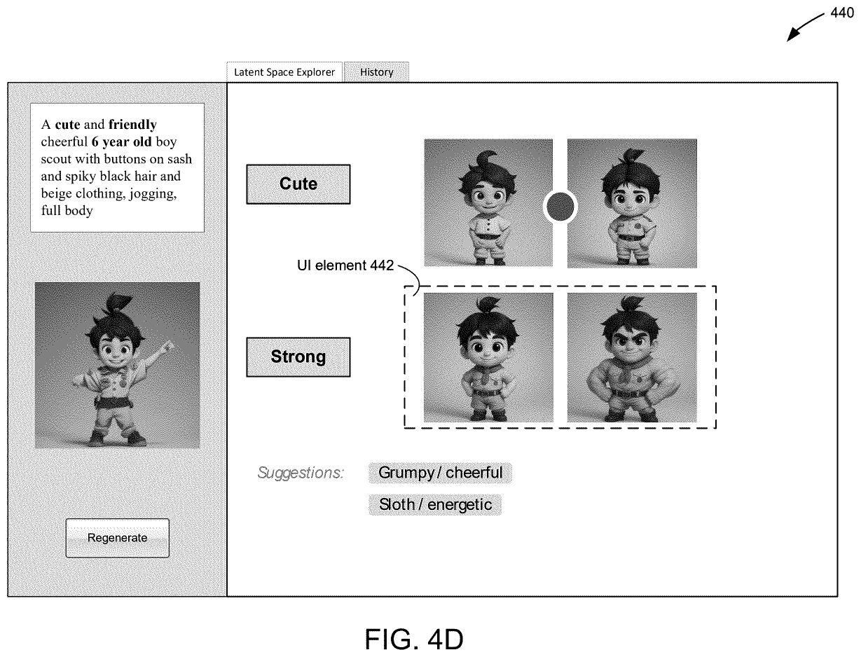

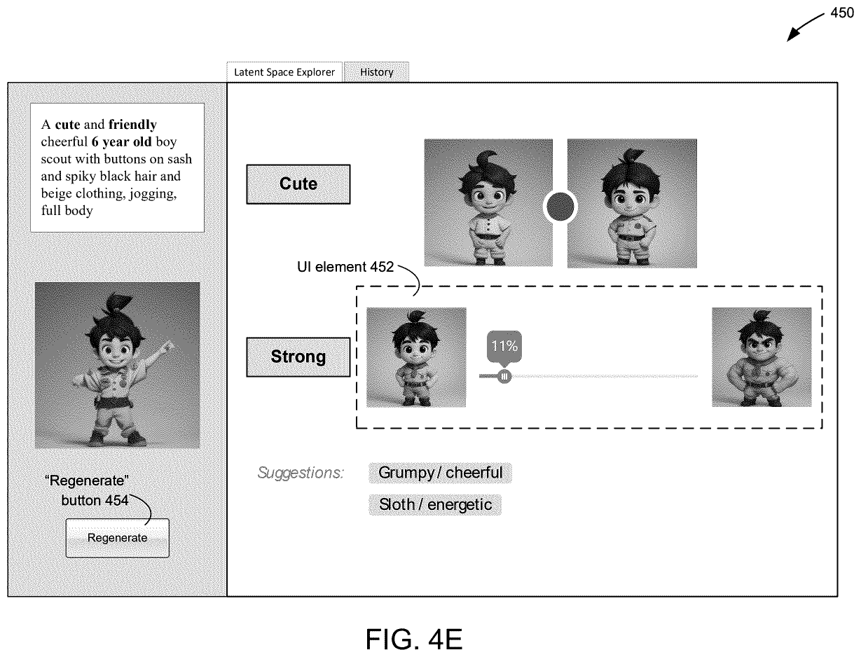

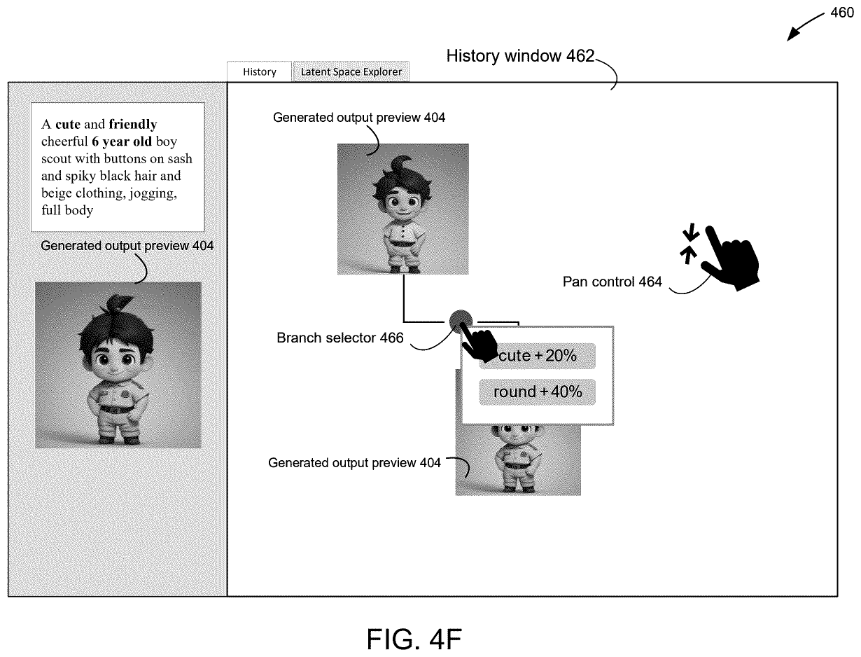

According to some embodiments, the user interface 202 provides input controls and outputs visualizations to allow for the modification of parameterized prompt attributes 306 (discussed further in conjunction with FIGS. 3-6). In particular, the user interface 202 allows user interaction with the software application 104 and modification of specific UI elements as generated by the prompt generator module 208 (discussed further below, in conjunction with FIGS. 3-4) through any feasible input device (not shown). The user interface 202 outputs information through a display. The user interface 202 accepts user inputs and forwards instructions to the prompt analyzer module 204, the UI generation module 206, and the prompt generator module 208, in accordance with the techniques described herein. Specific elements of the user interface 202 are discussed further in conjunction with FIGS. 4A-4F.

In operation, the prompt analyzer module 204 receives an initial prompt 302 and generates parameterized prompt attributes 306. The initial prompt 302 and the parameterized prompt attributes 306 are described in greater detail below in conjunction with FIG. 3.

In some embodiments, the prompt analyzer module 204 configures a request for a generative AI model 112 by combining the initial prompt 302 with an instruction that directs identification of the parameterized prompt attributes 306 and generation of associated metadata. The prompt analyzer module 204 invokes the generative AI model 112, and the generative AI model 112 processes the request to segment the natural language of the initial prompt 302, extract descriptive adjectives, numeric values, and stylistic cues, and infer associated intensity or range values. The generative AI model 112 returns a structured response that comprises parameterized prompt attributes 306.

In some embodiments, the prompt analyzer module 204 parses the structured response and normalizes each attribute to a canonical identifier 330 (e.g., a standardized, unambiguous name used internally to represent a particular concept or property). The prompt analyzer module 204 can further process associated metadata, including a minimum and a maximum (e.g., extremity values 332), and a default value 334 extracted from the initial prompt 302, and store the resulting parameterized prompt attributes 306 (and associated metadata) for downstream UI generation by the UI generation module 206. The canonical identifier 330, the extremity values 332, and the default value 334 are further discussed in conjunction with FIG. 3.

For example, the prompt analyzer module 204 can receive terms such as young, child, and juvenile from the structured response and map each term to canonical identifier 330 “age.” In some embodiments, the prompt analyzer module 204 can then retrieve associated metadata including a minimum value of zero, a maximum value of one hundred, and a default value of eight extracted from the initial prompt 302. The prompt analyzer module 204 stores the parameterized prompt attribute 306 having the canonical attribute identifier of “age” and the associated metadata for the minimum and the maximum values.

In some embodiments, the prompt analyzer module 204 can analyze a prompt and generate additional suggested parameterized prompt attributes 306 (displayed via the user interface 202) to add to the prompt by modification of associated UI elements, as further discussed in conjunction with FIG. 4A.

The UI generation module 208 receives the parameterized prompt attributes 306 and associated metadata from the prompt analyzer module 204 and is responsible for generating corresponding generated UI elements to represent the parameterized prompt attributes 306. The UI generation module 208 constructs a request for the generative AI model 112 that specifies generation of a user interface schema including interactive generated UI elements. The UI generation module 208 invokes the generative AI model 112, and the generative AI model 112 processes the request to map the parameterized prompt attributes 306 to one or more generated UI elements (e.g., a UI schema) to be displayed by the user interface 202.

In some embodiments, the UI generation module 208 can generate processed parameterized prompt attributes 306 (e.g., normalized extremity values 332 and default values 334) for use within generated UI elements 310. Specifically, raw data as generated by the prompt analyzer module 204 (e.g., extremity values 332 and default values 334) may not be suitable for use as numeric positions suitable for UI slider endpoints and UI slider placements.

In some embodiments, the UI generation module 208 can map an attribute with a numeric range to a slider UI element. The UI generation module 208 can map parameterized prompt attributes 306 to other UI elements such as a radio button, a binary attribute to a toggle or checkbox UI element, or a color attribute to a color picker UI element. The UI generation module 208 stores generated UI elements 310 via the user interface 202.

The prompt generator module 206 can interpret values of the generated UI elements by mapping values to a corresponding parameterized prompt attribute 306 and can then generate an updated prompt 314, discussed in greater detail below in conjunction with FIGS. 3-4. Specifically, the prompt generator module 206 generates the updated prompt 314 by replacing or augmenting the corresponding parameterized prompt attributes 306 in the initial prompt 302 with terms or numeric qualifiers that reflect values within the generated UI elements. The prompt generator module 206 constructs a request for the generative AI model 112 that includes a generation request for the updated prompt 314. Specifically, the generative AI model 112 processes the request and generates an updated prompt 314 that aligns with selected UI element values.

For example, a slider value of 20 for a parameterized prompt attribute 306 of “age” can yield a phrase “20-year-old” in the updated prompt. In another example, a slider value of eighty for a parameterized prompt attribute 306 “positive emotion intensity” yields a descriptor “very joyful” in the updated prompt 314.

### Example Workflow

FIG. 3 illustrates a detailed view of a workflow diagram 300, according to various embodiments. As shown, FIG. 3 follows the data flow of software application 104 as a user interacts with software application 104. FIG. 3 includes an initial prompt 302, a prompt analyzer module 204, parameterized prompt attributes 306, a UI generation module 206, generated UI elements 310, a prompt generator module 208, an updated prompt 314, a generative AI model 112A, and a generated output 318. Further, FIG. 3 also includes slider extremity outputs 320.

The initial prompt 302 includes natural language text that describes a user-intended output of generative AI (e.g., a 2D image or a 3D model) and can include descriptive adjectives, numeric values, and stylistic cues. In some embodiments, the initial prompt 302 can be received via a text-entry field or voice-to-text input by the user in user interface 202. The initial prompt 302 is forwarded to the prompt analyzer module 204 for identification and generation of parameterized prompt attributes and associated metadata. In some embodiments, the initial prompt 302 can span multiple sentences or clauses and can reference object properties or a scene context.

The prompt analyzer module 204 receives the initial prompt 302 and constructs a structured request by combining the initial prompt 302 with extraction and generation instructions. The prompt analyzer module 204 segments natural language of the initial prompt 302, extracts descriptive adjectives, numeric values, and stylistic cues, and infers associated intensity or range values.

In some embodiments, the prompt analyzer module 204 maps each extracted attribute to a canonical attribute identifier (e.g., canonical identifier 330). The prompt analyzer module 204 retrieves ranges and populates attribute metadata by assigning minimum, maximum (e.g., extremity values 332), and default values 334 (e.g., a user-intended value from the initial prompt 302). The prompt analyzer module 204 stores the resulting parameterized prompt attributes 306 for downstream processing by the UI generation module 208.

The parameterized prompt attributes 306 include structured representations of descriptive adjectives, numeric values, and stylistic cues extracted from the initial prompt 302. The parameterized prompt attributes 306 include canonical attribute identifiers (e.g., canonical identifiers 330) that unambiguously represent a concept or property. Each parameterized prompt attribute 306 further includes extremity values 332, a default value 334, and additional metadata 336. The extremity values 332 define minimum and maximum bounds for the canonical identifier 330. The default values 334 represent the values extracted from the initial prompt 302 (and the values that will later be modified by the generated UI elements 310). The additional metadata 336 can include attribute significance weight or contextual tags. For example, parameterized prompt attributes 306 can include intensity attributes such as emotion level or age range, stylistic attributes such as color saturation and detail level, and categorical attributes such as preset art style. The parameterized prompt attributes 306 are stored in a machine-readable format and are forwarded to the UI generation module 208 for construction of corresponding generated UI elements 310.

The UI generation module 206 receives the parameterized prompt attributes 306. The UI generation module 206 constructs a structured request specifying mapping of each parameterized prompt attribute 306 to one or more UI element types and invokes the generative AI model 112. The generative AI model 112 returns the generated UI elements 310 for each of the parameterized prompt attributes 306.

The generated UI elements 310 can include any type of UI element that intuitively allows for the modification of the default value 334. The additional metadata 336 can include information such as quantity information, discreteness indicators, variable type, and contextual tags that guide selection of interactive UI element types.

For example, the UI generation module 206 maps parameterized prompt attributes 306 with numeric extremity values to the generated UI elements 310, such as sliders. The UI generation module 208 can map numerically few and discrete parameterized prompt attributes 306 to radio buttons. Further, the UI generation module 206 can map binary parameterized prompt attributes 306 to toggle interactive UI elements. The UI generation module 208 can additionally map color-related parameterized prompt attributes 306 to a color picker interactive UI element. It is noted that the foregoing examples are not meant to be limiting, and that the UI elements can include any number, type, form, etc., of components, at any level of granularity, consistent with the scope of this disclosure.

The software application 104 can receive modifications of the generated UI elements 310 by the user, corresponding to modifications of the mapped parameterized prompt attributes 306. The prompt generator module 208 receives the generated UI elements 310 and any modifications of the generated UI elements 310 by the user.

The prompt generator module 208 generates an updated prompt 314 by replacing or augmenting the initial prompt 302 with descriptive terms that reflect the user-modified values of the generated UI elements 310. For example, a slider value of 20 for a canonical identifier 330 “hair length” yields a phrase “shoulder length” in the updated prompt 314. In another example, a radio button selection of “Watercolor” for a stylistic canonical identifier 330 results in a phrase “watercolor style” added to the updated prompt 314.

The prompt generator module 208 constructs a structured request that includes the initial prompt 302, mapped parameterized prompt attributes 306, and the user-modified values of the generated UI elements 310. The prompt generator module 208 invokes the generative AI model 112, and the generative AI model 112 processes the structured request and returns the updated prompt 314.

The updated prompt 314 includes augmented, modified, or replaced descriptive terms in the initial prompt 302 corresponding to each canonical attribute identifier (e.g., canonical identifier 330) and the associated default value 334. The updated prompt 314 can include numeric qualifiers, adjectival modifiers, and stylistic descriptors derived from the generated UI elements 310.

The generative AI model 112A is a specific subset of the generative AI models 112, which receives an input prompt and executes a generation pipeline to produce a 2D image output or a 3D model output. In other words, the generative AI model 112A is distinct from other generative AI models (e.g., other generative AI models 112 used by other various software modules).

In some embodiments, the generative AI model 112A applies neural network architectures, such as diffusion models for 2D images or neural implicit representations for 3D meshes, to interpret descriptive terms, numeric qualifiers, and stylistic descriptors in an input prompt.

In some embodiments, the generative AI model 112A can include multiple specialized sub-models for different modalities, for example, an image synthesis sub-model or a mesh reconstruction sub-model. The generative AI model 112 (and in general, the generative models 112) can be deployed on a server device or locally on a user device, depending on performance and privacy requirements.

In some embodiments, the input prompt to the generative AI model 112A can include the updated prompt 314, derived from the default values 334 (e.g., user-intended values within the initial prompt 302), and the output can be the generated output 318. In other embodiments, the prompt generator module 208 can receive the extremity values 332 of the parameterized prompt attributes 306 and generate a prompt for the generative AI model 112A (illustrated through dashed boxes) to create the slider extremity outputs 320 (also illustrated through a dashed box). The slider extremity outputs 320 can be used within the generated UI elements 310. Specifically, the slider extremity outputs 320 can be in the form of 3D models or 2D images and can be visually placed at the endpoints of UI slider elements that are included within generated UI elements 310 to signify to the user what the extremity-values of the sliders generate, providing further contextual information. A visualization of the slider elements is further described in greater detail below in conjunction with FIG. 4A-4D.

FIGS. 4A-4D illustrate conceptual diagrams of user interfaces 400 associated with a software application executing on one of the endpoint devices of FIG. 1, according to various embodiments.

As shown, FIG. 4A includes a textbox 402, a generated output preview 404, a latent space explorer 406, a parameterized prompt attribute “cute” 408, a UI element 410, and a suggestions section 412.

The textbox 402 provides a text-entry field in the user interface 202 that can receive an initial prompt 302. The initial prompt 302 appears as editable text within the textbox 402. In some embodiments, after receiving a text entry from the user, the prompt analyzer module 204 processes the initial prompt 302 to identify substrings corresponding to parameterized prompt attributes 306. Identified substrings can render in bold within the textbox 402 to indicate extraction of parameterized prompt attributes 306.

The generated output preview 404 provides a visualization of a generated output 318 as generated by a generative AI model 112A using the initial prompt 302 as an input prompt (e.g., contents of the textbox 402 as shown in FIG. 4A). In some embodiments, the generated output preview 404 can display a 2D image or 3D model prior to any user adjustments of generated UI elements 310. The generated output preview 404 enables user comparison of subsequent refinements made via the latent space explorer 406.

The latent space explorer 406 can display the generated UI elements 310 for modifying parameterized prompt attributes 306. In operation, this is shown in FIG. 4A through the visualization of the parameterized prompt attribute “cute” 408 and the UI element 410, discussed in greater detail directly below. In some embodiments, the latent space explorer 406 can contain multiple generated UI elements 310 in addition to suggestions sections 412.

The parameterized prompt attribute “cute” 408 corresponds to a first parameterized prompt attribute 306 detected by the prompt analyzer module 204 and generated by the UI generation module 206. As shown, the parameterized prompt attribute “cute” 408 is displayed within the latent space explorer 406. The software application 104 can receive modifications to the intensity values associated with parameterized prompt attribute “cute” 408 by interacting with the UI element 410.

As shown, the generated UI element 410 is mapped to the parameterized prompt attribute “cute” 408. The UI generation module 208 populates the UI element 410 with images (e.g., slider extremity outputs 320) containing maximum and minimum values associated with the parameterized prompt attribute “cute” 408. User selection of UI element 410 (described further in detail below in conjunction with FIG. 4B) enables discrete adjustments of the parameterized prompt attribute “cute” 408 in an intuitive manner.

The suggestions section 412 can display additional parameterized prompt attributes 306 available for modifying the generated output preview 404. In operation, the suggestions section 412 can be populated by the prompt analyzer module 204, which can analyze the initial prompt 302 and construct a request to the generative AI model 112 for additional suggestions of parameterized prompt attributes 306. The large language model 114 can return these suggestions, which the UI generation module 208 can then insert into the suggestions section 412. Contents of the suggestions section 412 can correspond to a parameterized prompt attribute 306 with associated canonical identifier 330 and additional metadata 336. User selection of a parameterized prompt attribute 306 within the suggestions section 412 causes the UI generation module 208 to generate a new generated UI element 310 (as further described in greater detail in conjunction with FIG. 4C and FIG. 4D).

As shown, FIG. 4B includes a UI element 422. The UI element 422 expands to show a slider upon selection of the UI element 410 in FIG. 4A. The UI element 422 can include a slider track with a selection node in addition to minimum and maximum extremity images (e.g., slider extremity outputs 320) associated with the parameterized prompt attribute “cute” 408 positioned at minimum and maximum endpoints. The software application 104 can receive a user manipulation of the selection node along the slider track to interpolate between slider extremity outputs 320 and update the generated output preview 404 after selection of the “regenerate button” (discussed in greater detail in conjunction with FIG. 4F).

As shown, FIG. 4C includes suggestion selection 432. The software application 104 receives the suggestion selection 432 corresponding to a weak-to-strong parameterized prompt attribute 306. The software application 104 invokes the UI generation module 208 to generate a UI element 442 (shown in FIG. 4D) associated with a parameterized prompt attribute 306 of “strong”.

FIG. 4D includes a UI element 442. The UI generation module 208 constructs a request to the generative AI model 112 to generate slider extremity outputs 320. The UI generation module 208 parses the response and generates the UI element 442 shown in FIG. 4D. The software application 104 can then receive a user selection of the UI element 442.

FIG. 4E includes a UI element 452 and a “regenerate” button 454. The UI element 452 is displayed within the latent space explorer 406 as a slider configured for adjusting an intensity of the parameterized prompt attribute 306 “strong”. The slider endpoints represent minimum and maximum extremity values 332, and the software application 104 can receive a user adjustment of the UI element 452 to modify an intensity of the parameterized prompt attribute 306 of “strong”. In some embodiments, the software application 104 can receive a user selection of the “regenerate” button 454 and invoke the workflow described in workflow diagram 300 (e.g., as described in greater detail in conjunction with FIG. 3). As shown in FIG. 4F, after a user selection of the “regenerate” button 454, the software application 104 generates a new generated output preview 404.

FIG. 4F includes a history window 462, a pan control 464, and a branch selector 466. The history window 462 displays a navigable sequence of generated output previews 404 arranged as a branching graph. The pan control 464 enables the user to scroll within the history window 462 to view different portions of the graph. The branch selector 466 appears when the software application 104 receives a selection of a branch connecting two generated output previews 404, which include modifications of parameterized prompt attributes 306 (e.g., an increase in cuteness by 20 percent and an increase in roundness by 40 percent).

In other examples, additional UI elements can include dropdown menu UI elements for selecting output resolution or 3D file format (e.g., OBJ, FBX, glTF), toggle UI elements for enabling post-processing effects (e.g., bloom, vignette), color picker UI elements for specifying primary and accent colors, slider UI elements for controlling depth-of-field intensity, numeric input UI elements for entering seed values or aspect ratios, multi-select list UI elements for choosing scene objects (e.g., trees, vehicles, furniture), preset thumbnail UI elements for applying predefined art styles (e.g., watercolor, oil painting, ink sketch), radio button group UI elements for selecting camera angles (e.g., front, side, isometric), checklist UI elements for toggling environmental props (e.g., trees, animals, buildings), and a time-picker UI element for time-based lighting conditions (e.g., dawn, noon, dusk).

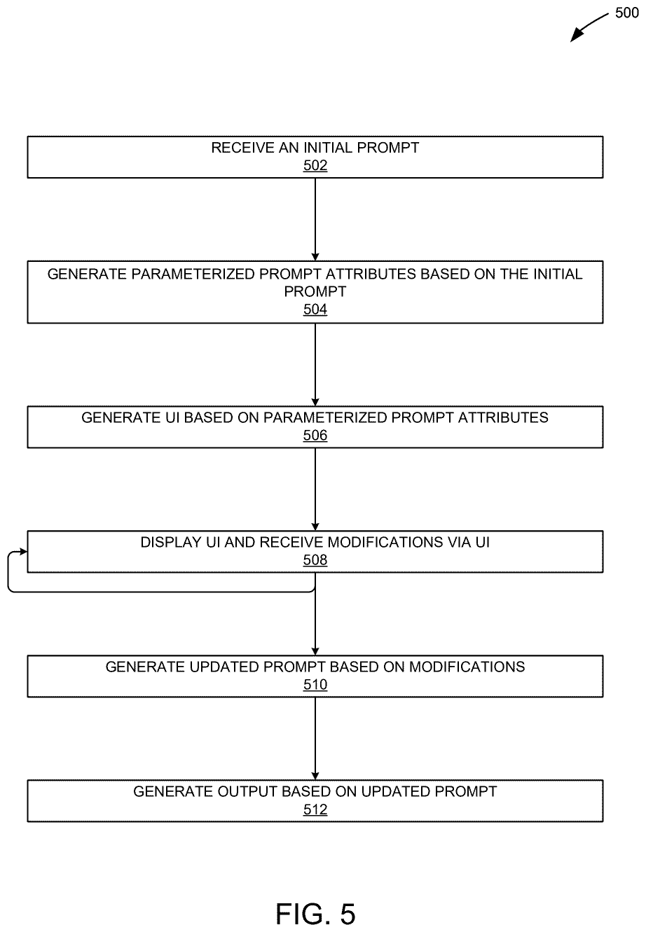

FIG. 5 illustrates a method for generating dynamic user interfaces to modify generative AI prompts, according to some embodiments. As shown in FIG. 5, the method 500 begins at step 502. At step 502, the software application 104 receives an initial prompt 302 via a text-entry field in a user interface 202 (e.g., as described above in conjunction with FIGS. 1, 2, 3, and 4A-4F).

At step 504, the software application 104 generates parameterized prompt attributes 306 based on the initial prompt 302. Specifically, the software application 104 invokes a prompt analyzer module 204 to analyze the initial prompt 302 and constructs an extraction request to a generative AI module 112. The software application 104, via the prompt analyzer module 204, receives a structured response, parses descriptive adjectives, numeric values, and stylistic cues into parameterized prompt attributes 306, maps each of the parameterized prompt attributes 306 to a canonical identifier 330, generates extremity values 332 and default values 334, and stores parameterized prompt attributes 306 for use in UI generation (e.g., as described above in conjunction with FIGS. 1, 2, 3, and 4A-4F).

At step 506, the software application 104 generates a UI based on the parameterized prompt attributes 306. Specifically, the software application 104 invokes a UI generation module 208 with parameterized prompt attributes 306 and associated metadata. The UI generation module 208 constructs a UI schema request to generative AI module 112 and receives and parses the UI schema, and instantiates generated UI elements 310, such as sliders, radio buttons, toggles, color pickers, multi-select lists, and dropdown menus (e.g., as described above in conjunction with FIGS. 1, 2, 3, and 4A-4F).

At step 508, the software application 104 displays the UI and receives modifications via the UI. Specifically, the software application 104 displays the UI elements 310 within a latent space explorer 406 of a user interface 202 and can receive user modifications via interaction with the generated UI elements 310 (for example, slider adjustments or radio button selections). The software application 104 then forwards the modified generated UI elements 310, mapped to values of parameterized prompt attributes 306, to a prompt generator module 206. Step 508 can be repeated for multiple parameterized prompt attributes 306 and mapped generated UI elements 310 as needed (e.g., as described above in conjunction with FIGS. 1, 2, 3, and 4A-4F).

At step 510, the software application 104 generates an updated prompt 314 based on modifications of the UI. Specifically, the software application 104 invokes the prompt generator module 206 with updated values of the parameterized prompt attributes 306 and the initial prompt 302. The prompt generator module 206 generates the updated prompt 314 by replacing, modifying, augmenting, or adding the parameterized prompt attributes 306 in the initial prompt 302 with updated parameterized prompt attributes 306 (e.g., as described above in conjunction with FIGS. 1, 2, 3, and 4A-4F).

At step 512, the software application 104 generates an output based on the updated prompt. Specifically, the software application 104 invokes a generative AI model 112A with the updated prompt 314, receives a generated output 318 comprising a 2D image or 3D model, and displays the generated output 318 in a generated output preview 404 of the user interface 202 (e.g., as described above in conjunction with FIGS. 1, 2, 3, and 4A-4F).

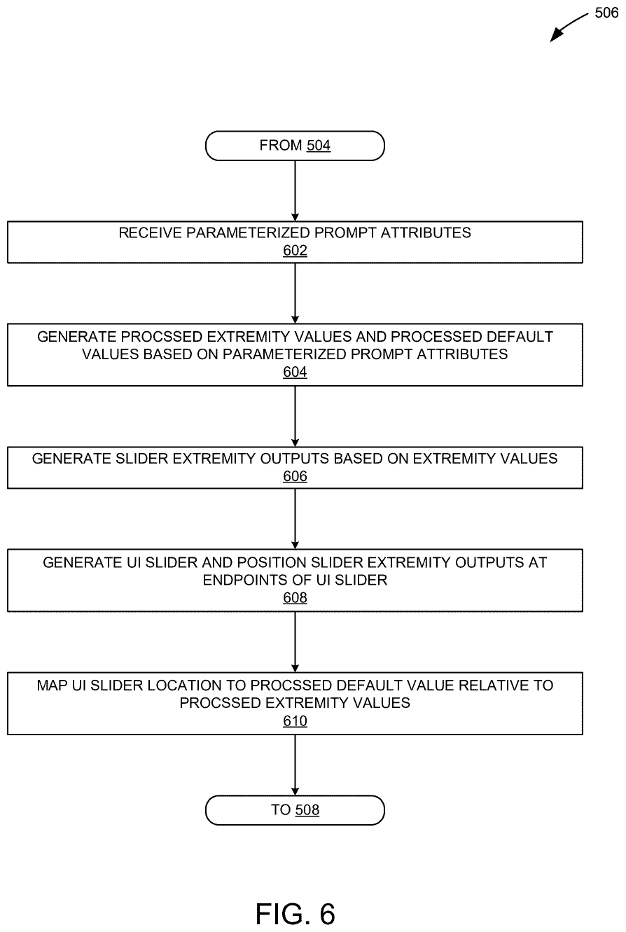

FIG. 6 illustrates a method for generating dynamic user interface slider elements based on parameterized prompt attributes 506, according to some embodiments. As shown in FIG. 6, the method 506 begins at step 602. At step 602, the software application 104 receives parameterized prompt attributes 306, where each parameterized prompt attribute 306 includes a canonical identifier 330, extremity values 332, and user-intended values 334 (e.g., as described above in conjunction with FIGS. 1, 2, 3, and 4A-4F).

At step 604, the software application 104 generates processed extremity values 332 and default values 334 based on parameterized prompt attributes 306. Specifically, the UI generation module 208 generates normalized extremity values 332 and default values 334 for UI element placement to convert raw data into numeric positions suitable for slider endpoints and slider placement (e.g., as described above in conjunction with FIGS. 1, 2, 3, and 4A-4F).

At step 606, the software application 104 generates slider extremity outputs 320 based on extremity values 332 (e.g., 2D images or 3D models). The software application 104 can use the processed extremity values from step 604, invoke the prompt generator module 208 to generate a prompt for generative AI model 112A, and then invoke the generative AI model 112A (e.g., as described above in conjunction with FIGS. 1, 2, 3, and 4A-4F).

At step 608, the software application 104 generates a UI slider and positions the slider extremity outputs 332 at endpoints of the UI slider. Specifically, the software application 104 can invoke UI generation module 206 to generate the UI slider. The UI generation module 206 can then position the slider extremity outputs 320 at the minimum and maximum endpoints of the UI slider (e.g., as described above in conjunction with FIGS. 1, 2, 3, and 4A-4F).

At step 610, the software application 104 maps the UI slider to the default value relative to the extremity values. Specifically, the UI generation module 208 can position the location of the UI slider selection node within the UI slider track at a location proportional to the processed default value 334 (generated in step 604) relative to the processed normalized extremity values (also generated in step 604) (e.g., as described above in conjunction with FIGS. 1, 2, 3, and 4A-4F).

### Computing Device Overview

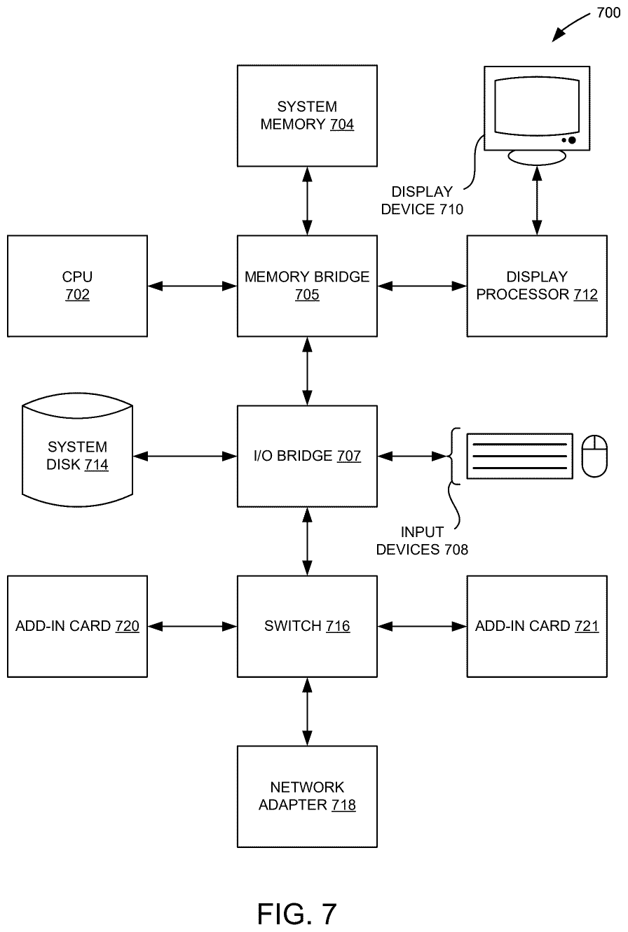

FIG. 7 is a more detailed illustration of a computing device that can implement the functionalities of the entities illustrated in FIG. 1, according to various embodiments. This Figure in no way limits or is intended to limit the scope of the various embodiments. In various implementations, system 700 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 700 may be coupled together to practice one or more aspects of the various embodiments.

As shown, system 700 includes a central processing unit (CPU) 702 and a system memory 704 communicating via a bus path that may include a memory bridge 705. CPU 702 includes one or more processing cores, and, in operation, CPU 702 is the master processor of system 700, controlling and coordinating operations of other system components. System memory 704 stores software applications and data for use by CPU 702. CPU 702 runs software applications and optionally an operating system. Memory bridge 705, which may be, e.g., a Northbridge chip, is connected via a bus or other communication path (e.g., a HyperTransport link) to an I/O (input/output) bridge 707. I/O bridge 707, which may be, e.g., a Southbridge chip, receives user input from one or more user input devices 708 (e.g., keyboard, mouse, joystick, digitizer tablets, touch pads, touch screens, still or video cameras, motion sensors, and/or microphones) and forwards the input to CPU 702 via memory bridge 705.

A display processor 712 is coupled to memory bridge 705 via a bus or other communication path (e.g., a PCI Express, Accelerated Graphics Port, or HyperTransport link); in one embodiment display processor 712 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 704.

Display processor 712 periodically delivers pixels to a display device 710 (e.g., a screen or conventional CRT, plasma, OLED, SED or LCD based monitor or television). Additionally, display processor 712 may output pixels to film recorders adapted to reproduce computer generated images on photographic film. Display processor 712 can provide display device 710 with an analog or digital signal. In various embodiments, one or more of the various graphical user interfaces set forth in FIG. 3 are displayed to one or more users via display device 710, and the one or more users can input data into and receive visual output from those various graphical user interfaces.

A system disk 714 is also connected to I/O bridge 707 and may be configured to store content and applications and data for use by CPU 702 and display processor 712. System disk 714 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 716 provides connections between I/O bridge 707 and other components such as a network adapter 718 and various add-in cards 720 and 721. Network adapter 718 allows system 700 to communicate with other systems via an electronic communications network, and may include wired or wireless communication over local area networks and wide area networks such as the Internet.

Other components (not shown), including USB or other port connections, film recording devices, and the like, may also be connected to I/O bridge 707. For example, an audio processor may be used to generate analog or digital audio output from instructions and/or data provided by CPU 702, system memory 704, or system disk 714. Communication paths interconnecting the various components in FIG. 7 may be implemented using any suitable protocols, such as PCI (Peripheral Component Interconnect), PCI Express (PCIE), AGP (Accelerated Graphics Port), HyperTransport, or any other bus or point-to-point communication protocol(s), and connections between different devices may use different protocols, as is known in the art.

In one embodiment, display processor 712 incorporates circuitry optimized for graphics and video processing, including, for example, video output circuitry, and constitutes a graphics processing unit (GPU). In another embodiment, display processor 712 incorporates circuitry optimized for general purpose processing. In yet another embodiment, display processor 712 may be integrated with one or more other system elements, such as the memory bridge 705, CPU 702, and I/O bridge 707 to form a system on chip (SoC). In still further embodiments, display processor 712 is omitted and software executed by CPU 702 performs the functions of display processor 712.

Pixel data can be provided to display processor 712 directly from CPU 702. In some embodiments, instructions and/or data representing a scene are provided to a render farm or a set of server computers, each similar to system 700, via network adapter 718 or system disk 714. The render farm generates one or more rendered images of the scene using the provided instructions and/or data. These rendered images may be stored on computer-readable media in a digital format and optionally returned to system 700 for display. Similarly, stereo image pairs processed by display processor 712 may be output to other systems for display, stored in system disk 714, or stored on computer-readable media in a digital format.

Alternatively, CPU 702 provides display processor 712 with data and/or instructions defining the desired output images, from which display processor 712 generates the pixel data of one or more output images, including characterizing and/or adjusting the offset between stereo image pairs. The data and/or instructions defining the desired output images can be stored in system memory 704 or graphics memory within display processor 712. In an embodiment, display processor 712 includes 3D rendering capabilities for generating pixel data for output images from instructions and data defining the geometry, lighting shading, texturing, motion, and/or camera parameters for a scene. Display processor 712 can further include one or more programmable execution units capable of executing shader programs, tone mapping programs, and the like.

Further, in other embodiments, CPU 702 or display processor 712 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 702, display processor 712, or one or more other processing devices or any combination of these different processors.

CPU 702, render farm, and/or display processor 712 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 700 may be a robot or robotic device and may include CPU 702 and/or other processing units or devices and system memory 704. In such embodiments, system 700 may or may not include other elements shown in FIG. 7. System memory 704 and/or other memory units or devices in system 700 may include instructions that, when executed, cause the robot or robotic device represented by system 700 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 704 is connected to CPU 702 directly rather than through a bridge, and other devices communicate with system memory 704 via memory bridge 705 and CPU 702. In other alternative topologies display processor 712 is connected to I/O bridge 707 or directly to CPU 702, rather than to memory bridge 705. In still other embodiments, I/O bridge 707 and memory bridge 705 might be integrated into a single chip. The particular components shown herein are optional; for instance, any number of add-in cards or peripheral devices might be supported. In some embodiments, switch 716 is eliminated, and network adapter 718 and add-in cards 720, 721 connect directly to I/O bridge 707.

In sum, the disclosed embodiments set forth techniques for refining generative AI outputs through dynamically generated user interfaces within a software application. In particular, the disclosed techniques set forth a process that involves collecting an initial natural language prompt from a user and employing generative AI model to analyze the prompt and identify parameterized prompt attributes such as descriptive adjectives, numeric values, or stylistic cues. Based on the identified parameterized prompt attributes, the software application generates a user interface that includes interactive UI elements such as sliders, toggles, and discrete selectors. A user may adjust parameterized prompt attributes via such UI elements, and the software application updates the natural language prompt based on such adjustments. The software application then invokes one or more generative AI models using the modified prompt to generate a refined generative AI output and returns associated information to the software application for display.

One technical advantage of the disclosed techniques relative to the prior art is that the disclosed techniques enable more precision and control over parameterized prompt attributes. As a result, the outputs of generative AI can more accurately align with user intent. Specifically, given that the disclosed techniques do not rely on semantic ambiguity inherent in text-based prompts, users no longer need to anticipate which terms best meet user intent. Another technical advantage of the disclosed techniques includes greater time efficiency and a more rapid convergence to a user-intended output of generative AI. In particular, the disclosed techniques also mitigate trial-and-error processes associated with manual prompt rewriting, thereby decreasing the number of cycles required to achieve a satisfactory output of generative AI. As the number of cycles diminishes, resource consumption and latency also decline. An additional technical advantage of the disclosed techniques includes the improved overall quality and consistency of generative outputs, together with reduced computational overhead. By exposing prompt attributes as discrete, parameterized parameters, the generative AI system can ensure that each iterative adjustment generates predictable changes in outputs of generative AI, which minimizes off-target artifacts and variability. Consequently, fewer generation cycles are needed to reach user-satisfactory outputs, which can conserve processing resources (e.g., GPU time, memory) and also reduce environmental impact.

1. In some embodiments, a computer-implemented method for generating prompts for generative artificial intelligence (AI) models comprises: receiving an initial prompt comprising natural language; generating a plurality of parameterized prompt attributes based on the initial prompt; generating a plurality of UI elements based on the parameterized prompt attributes; receiving user input modifying one or more of the UI elements; and generating an updated prompt based on the initial prompt and the user input.

2. The computer-implemented method of clause 1, further comprising extracting at least one of descriptive adjectives, numeric values, or stylistic cues from the initial prompt to generate the parameterized prompt attributes.

3. The computer-implemented method of any of clauses 1-2, wherein each parameterized prompt attribute included in the plurality of parameterized prompt attributes comprises a canonical identifier.

4. The computer-implemented method of any of clauses 1-3, wherein each parameterized prompt attribute included in the plurality of parameterized prompt attributes further comprises at least one of a minimum value, a maximum value, or a default value.

5. The computer-implemented method of any of clauses 1-4, further comprising generating visual representations of the minimum value and the maximum value and displaying the visual representations at endpoints of a slider UI element.

6. The computer-implemented method of any of clauses 1-5, wherein generating the plurality of UI elements comprises generating a slider UI element for at least one parameterized prompt attribute included in the plurality of parameterized prompt attributes.

7. The computer-implemented method of any of clauses 1-6, wherein generating the plurality of UI elements comprises generating a toggle UI element for at least one parameterized prompt attribute included in the plurality of parameterized prompt attributes.

8. The computer-implemented method of any of clauses 1-7, further comprising modifying the updated prompt to incorporate descriptive terms that correspond to the user input.

9. The computer-implemented method of any of clauses 1-8, further comprising generating, via a generative AI model, an output comprising at least one of a two-dimensional image or a three-dimensional model based on the updated prompt.

10. The computer-implemented method of any of clauses 1-9, further comprising generating one or more suggestions for additional parameterized prompt attributes based on the initial prompt.

11. In some embodiments, one or more non-transitory computer readable media store instructions that, when executed by one or more processors, cause the one or more processors to generate prompts for generative artificial intelligence (AI) models, by performing the operations of: receiving an initial prompt comprising natural language; generating a plurality of parameterized prompt attributes based on the initial prompt; generating a plurality of UI elements based on the parameterized prompt attributes; receiving user input modifying one or more of the UI elements; and generating an updated prompt based on the initial prompt and the user input.

12. The one or more non-transitory computer readable media of clause 11, wherein the operations further comprise extracting at least one of descriptive adjectives, numeric values, or stylistic cues from the initial prompt to generate the parameterized prompt attributes.

13. The one or more non-transitory computer readable media of any of clauses 11-12, wherein each parameterized prompt attribute included in the plurality of parameterized prompt attributes comprises at least one of a canonical identifier, a minimum value, a maximum value, or a default value.

14. The one or more non-transitory computer readable media of any of clauses 11-13, wherein the operations further comprise generating visual representations of the minimum value and the maximum value and displaying the visual representations at endpoints of a slider UI element.

15. The one or more non-transitory computer readable media of any of clauses 11-14, wherein generating the plurality of UI elements comprises generating a slider UI element or a toggle UI element based on a type of parameterized prompt attribute.

16. The one or more non-transitory computer readable media of any of clauses 11-15, wherein the operations further comprise modifying the updated prompt to incorporate descriptive terms corresponding to the user input.

17. The one or more non-transitory computer readable media of any of clauses 11-16, wherein the operations further comprise generating, via a generative AI model, an output comprising at least one of a two-dimensional image or a three-dimensional model based on the updated prompt.

18. The one or more non-transitory computer readable media of any of clauses 11-17, wherein the operations further comprise displaying a graphical history of prompt updates and corresponding generative AI model outputs.

19. The one or more non-transitory computer readable media of any of clauses 11-18, wherein the operations further comprise generating a branching graph that correlates changes in the updated prompt with variations in outputs generated by a generative AI model.

20.In some embodiments, a system comprises: one or more memories that include instructions; and one or more processors that are coupled to the one or more memories and that, when executing the instructions, are configured to generate prompts for generative artificial intelligence (AI) models, by performing the operations of: receiving an initial prompt comprising natural language; generating a plurality of parameterized prompt attributes based on the initial prompt; generating a plurality of UI elements based on the parameterized prompt attributes; receiving user input modifying one or more of the UI elements; and generating an updated prompt based on the initial prompt and the user input.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating prompts for generative artificial intelligence (AI) models, the method comprising:
receiving an initial prompt comprising natural language;
generating a plurality of parameterized prompt attributes based on the initial prompt;
generating a plurality of UI elements based on the parameterized prompt attributes;
receiving user input modifying one or more of the UI elements; and
generating an updated prompt based on the initial prompt and the user input.

2. The computer-implemented method of claim 1, further comprising extracting at least one of descriptive adjectives, numeric values, or stylistic cues from the initial prompt to generate the parameterized prompt attributes.

3. The computer-implemented method of claim 1, wherein each parameterized prompt attribute included in the plurality of parameterized prompt attributes comprises a canonical identifier.

4. The computer-implemented method of claim 3, wherein each parameterized prompt attribute included in the plurality of parameterized prompt attributes further comprises at least one of a minimum value, a maximum value, or a default value.

5. The computer-implemented method of claim 4, further comprising generating visual representations of the minimum value and the maximum value and displaying the visual representations at endpoints of a slider UI element.

6. The computer-implemented method of claim 1, wherein generating the plurality of UI elements comprises generating a slider UI element for at least one parameterized prompt attribute included in the plurality of parameterized prompt attributes.

7. The computer-implemented method of claim 1, wherein generating the plurality of UI elements comprises generating a toggle UI element for at least one parameterized prompt attribute included in the plurality of parameterized prompt attributes.

8. The computer-implemented method of claim 1, further comprising modifying the updated prompt to incorporate descriptive terms that correspond to the user input.

9. The computer-implemented method of claim 1, further comprising generating, via a generative AI model, an output comprising at least one of a two-dimensional image or a three-dimensional model based on the updated prompt.

10. The computer-implemented method of claim 1, further comprising generating one or more suggestions for additional parameterized prompt attributes based on the initial prompt.

11. One or more non-transitory computer readable media storing instructions that, when executed by one or more processors, cause the one or more processors to generate prompts for generative artificial intelligence (AI) models, by performing the operations of:
receiving an initial prompt comprising natural language;
generating a plurality of parameterized prompt attributes based on the initial prompt;
generating a plurality of UI elements based on the parameterized prompt attributes;
receiving user input modifying one or more of the UI elements; and
generating an updated prompt based on the initial prompt and the user input.

12. The one or more non-transitory computer readable media of claim 11, wherein the operations further comprise extracting at least one of descriptive adjectives, numeric values, or stylistic cues from the initial prompt to generate the parameterized prompt attributes.

13. The one or more non-transitory computer readable media of claim 11, wherein each parameterized prompt attribute included in the plurality of parameterized prompt attributes comprises at least one of a canonical identifier, a minimum value, a maximum value, or a default value.

14. The one or more non-transitory computer readable media of claim 13, wherein the operations further comprise generating visual representations of the minimum value and the maximum value and displaying the visual representations at endpoints of a slider UI element.

15. The one or more non-transitory computer readable media of claim 11, wherein generating the plurality of UI elements comprises generating a slider UI element or a toggle UI element based on a type of parameterized prompt attribute.

16. The one or more non-transitory computer readable media of claim 11, wherein the operations further comprise modifying the updated prompt to incorporate descriptive terms corresponding to the user input.

17. The one or more non-transitory computer readable media of claim 11, wherein the operations further comprise generating, via a generative AI model, an output comprising at least one of a two-dimensional image or a three-dimensional model based on the updated prompt.

18. The one or more non-transitory computer readable media of claim 11, wherein the operations further comprise displaying a graphical history of prompt updates and corresponding generative AI model outputs.

19. The one or more non-transitory computer readable media of claim 11, wherein the operations further comprise generating a branching graph that correlates changes in the updated prompt with variations in outputs generated by a generative AI model.

20. A system, comprising:
one or more memories that include instructions; and
one or more processors that are coupled to the one or more memories and,
when executing the instructions, are configured to generate prompts for generative artificial intelligence (AI) models, by performing the operations of:
receiving an initial prompt comprising natural language;
generating a plurality of parameterized prompt attributes based on the initial prompt;
generating a plurality of UI elements based on the parameterized prompt attributes;
receiving user input modifying one or more of the UI elements; and
generating an updated prompt based on the initial prompt and the user input.
